(19) United States
(12) Patent Application Publication
(10) Pub. No.: US 2012/0100511 A1
(43) Pub. Date: Apr. 26, 2012

(54) DRAWING CARTOONS TO LEARN CURSIVE WRITING

(76) Inventor: Jonathan Fine, Brookline, MA (US)

(21) Appl. No.: 12/635,842

(22) Filed: Dec. 11, 2009

(51) Int. Cl. G09B 11/00

(52) U.S. Cl. 434/162

(57) ABSTRACT

The present invention comprises a method for the instruction of handwriting through the use of cartoon items. Certain cartoons and other drawings may be introduced and students asked to reproduce the cartoon items a number of times; until a desired proficiency is reached. Subsequently, the student may be made aware that a portion or all of the cartoon item also includes a handwriting element. The student may then be instructed in the reproduction of the handwriting element alone. Through this method the student may acquire the necessary skills to reproduce the handwriting element alone, or in combination with other handwriting elements, to achieve proficiency at reproducing the handwriting element. The end result being that handwriting may be learned efficiently in a manner that retains the students' interest.

### BACKGROUND OF THE INVENTION

1. Field of the Invention

The present invention relates generally to the field of education and particularly to a method for learning cursive handwriting.

2. Description of the Related Art

Many educational tools and methods of instructing students currently exist. It is often the case that to do anything properly, repetition and practice are the only means that lead to mastery of a desired skill. However, repetition is often extremely boring, causing many students to lose interest, put forth less than the appropriate effort, or even to give up completely.

Learning to master handwriting skills is a prime example of a skill that must be repeated to achieve mastery. To learn the appropriate motor skills, students are often required to painstakingly repeat certain movements. When the students are children, it is very difficult for the instructor to maintain the child's attention for the time necessary to achieve proficiency. There is little enjoyment in copying or tracing letters over and over again. Instructors are constantly challenged in coming up with new ways to keep the students' interest, yet convey the important lessons necessary for mastery.

An example of a more creative teaching method can be found in U.S. Pat. No. 2,447,213 to Sledge that discloses a teaching method for learning music through the use of colors and animals. The method employs a color code system in which each of the lines on a staff is provided with its own color. For example, the “G” line is colored blue to represent a street, and a small blue house is positioned at the end of the line. Animals are also used as markers to indicate specific notes, for example a goose would represent a “GG.” Thus, a child would be taught that a goose lives in the blue house at the end of the blue street. The child would then able to easily understand the specific lines each note is associated with.

U.S. Pat. No. 3,950,863 discloses a method of alphabet recognition and learning handwriting. The student is taught nine basic shapes, from which all the upper and lower case letters can be derived. Transparencies are also used for repetition and consistency.

U.S. Pat. No. 4,822,284 also discloses a device designed to instruct children in handwriting. The device comprises a rotatable disk with holes through which a writing instrument may be inserted. The disk is transparent so that various arcs and lines may be viewed as they are drawn. The disk is preferably rotated only in the clockwise direction to facilitate the correct formation of the desired letters.

These patents illustrate that animals and other interesting concepts may be used to increase the enjoyment level of what would otherwise be a tedious task. Although the above referenced inventions may be suitable for their desired results, they lack certain benefits provided by the present invention.

### BRIEF SUMMARY OF THE INVENTION

Therefore, it is an object of the present invention to provide a method of instruction that is easy to understand from the standpoint of both the instructor and the student.

It is a further object of the present invention to promote learning by providing a method that takes full advantage of students' natural tendency to want to have fun.

It is also an object of the present invention to lessen the tedious aspects that are appurtenant to classic repetitive learning methods.

The inventors have developed a unique method of teaching cursive writing after many children demonstrated difficulty with traditional methods. One of the inventors, an occupational therapist, was using popular and well-established programs to assist children in learning cursive writing. While some of his students were successful with learning cursive, others struggled with the creation of letters; a new approach was needed.

The second inventor, an art instructor, was teaching the children to draw cartoons by first showing them basic shapes and then expanding on these shapes. After observing these children in art class, the inventors made two observations. First, there is a similarity between the basic strokes of cartoons and cursive: they both have circles, ovals, loops and convex and concave curves. Second, when the students were drawing cartoons, their hands and arms became more relaxed and “loosened up”.

These two factors led the inventors to develop a new technique for teaching cursive writing based on incorporating art into learning cursive. Over the past years, they have implemented this method into their teaching and noticed significant improvements with children's handwriting. The children learned cursive faster, understood it better, and required less instruction. In addition, they enjoyed it much more than traditional writing programs that solely focus on the technical aspects of letter formation. Now, the students were able to create fun cartoon characters while learning cursive writing.

This new method will be helpful for teachers who want their children to learn cursive through a fun and innovative method, parents who want their child to learn cursive and want a step-by-step easy to understand approach, and occupational therapists who need a new approach to teaching writing.

### BRIEF DESCRIPTION OF THE SEVERAL VIEWS OF THE DRAWINGS

These and other features, aspects and advantages of the present invention will become better understood with reference to the following description, appended claims and accompanying drawings where:

FIG. 1 comprises examples of basic shapes of the present invention.

FIG. 2 comprises examples of embodiments of the present invention.

FIG. 3 comprises examples of embodiments of the present invention.

FIG. 4 comprises examples of embodiments of the present invention.

FIG. 5 comprises examples of embodiments of the present invention.

FIG. 6 comprises examples of embodiments of the present invention.

FIG. 7 comprises examples of embodiments of the present invention.

FIG. 8 comprises examples of embodiments of the present invention.

FIG. 9 comprises examples of embodiments of the present invention.

FIG. 10 comprises examples of embodiments of the present invention.

FIG. 11 comprises examples of embodiments of the present invention.

FIG. 12 comprises examples of embodiments of the present invention.

FIG. 13 comprises examples of embodiments of the present invention.

FIG. 14 comprises examples of embodiments of the present invention.

FIG. 15 comprises examples of embodiments of the present invention.

FIG. 16 comprises examples of embodiments of the present invention.

FIG. 17 comprises examples of embodiments of the present invention.

FIG. 18 comprises examples of embodiments of the present invention.

FIG. 19 comprises examples of embodiments of the present invention.

FIG. 20 comprises examples of embodiments of the present invention.

FIG. 21 comprises examples of embodiments of the present invention.

FIG. 22 comprises examples of embodiments of the present invention.

FIG. 23 comprises examples of embodiments of the present invention.

FIG. 24 comprises examples of embodiments of the present invention.

FIG. 25 comprises examples of embodiments of the present invention.

FIG. 26 comprises examples of embodiments of the present invention.

FIG. 27 comprises examples of embodiments of the present invention.

FIG. 28 comprises examples of embodiments of the present invention.

FIG. 29 comprises examples of embodiments of the present invention.

FIG. 30 comprises examples of embodiments of the present invention.

FIG. 31 comprises examples of embodiments of the present invention.

FIG. 32 comprises examples of embodiments of the present invention.

FIG. 33 comprises examples of embodiments of the present invention.

FIG. 34 comprises examples of embodiments of the present invention.

FIG. 35 comprises examples of embodiments of the present invention.

FIG. 36 comprises examples of embodiments of the present invention.

FIG. 37 comprises examples of embodiments of the present invention.

FIG. 38 comprises examples of embodiments of the present invention.

FIG. 39 comprises examples of embodiments of the present invention.

FIG. 40 comprises examples of embodiments of the present invention.

FIG. 41 comprises examples of embodiments of the present invention.

FIG. 42 comprises examples of embodiments of the present invention.

FIG. 43 comprises examples of embodiments of the present invention.

FIG. 44 comprises examples of embodiments of the present invention.

FIG. 45 comprises examples of embodiments of the present invention.

FIG. 46 comprises examples of embodiments of the present invention.

FIG. 47 comprises examples of embodiments of the present invention.

FIG. 48 comprises examples of embodiments of the present invention.

FIG. 49 comprises examples of embodiments of the present invention.

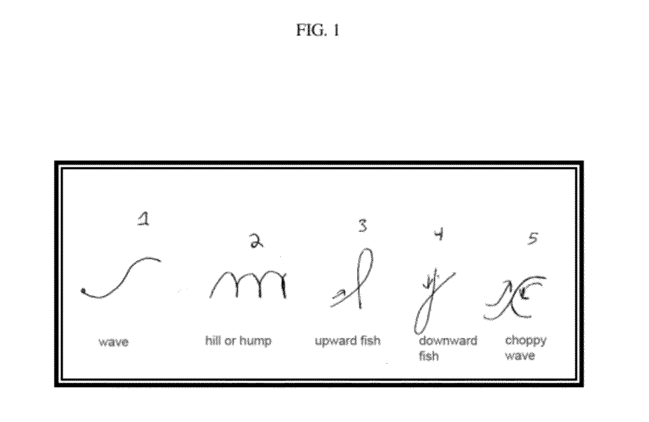

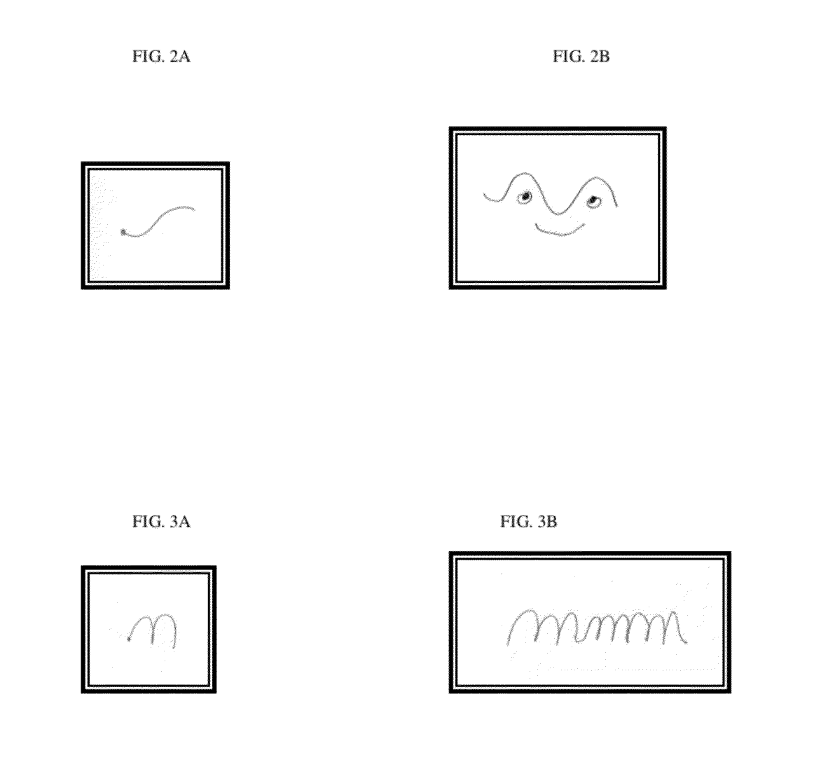

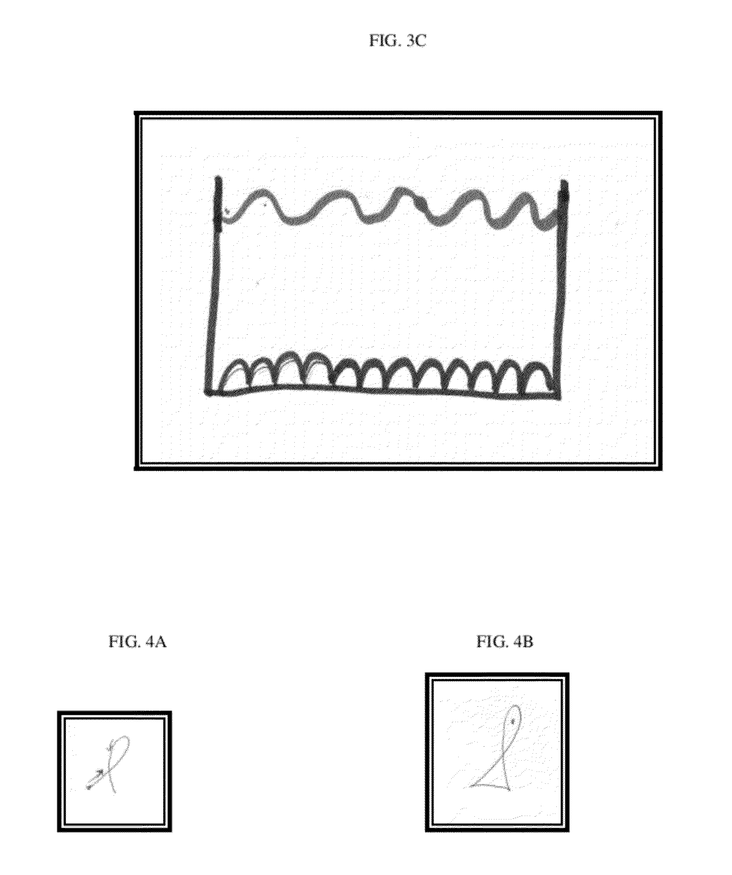

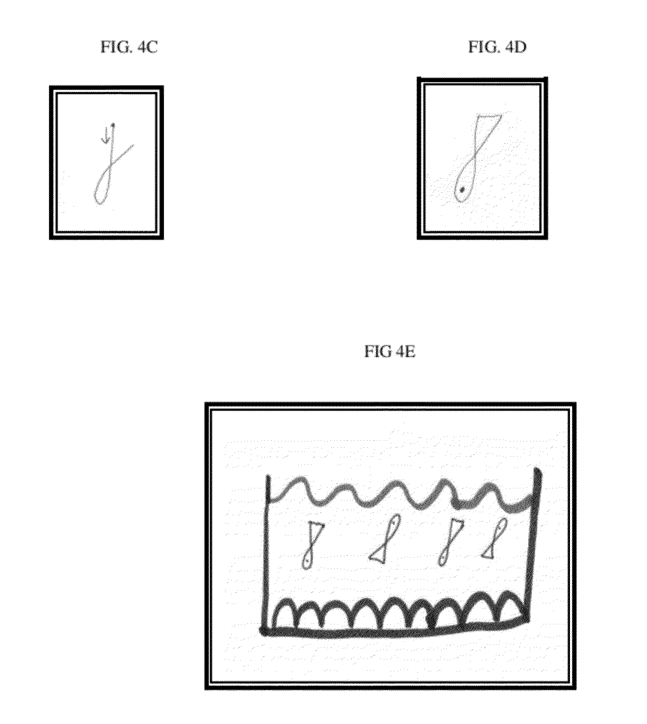

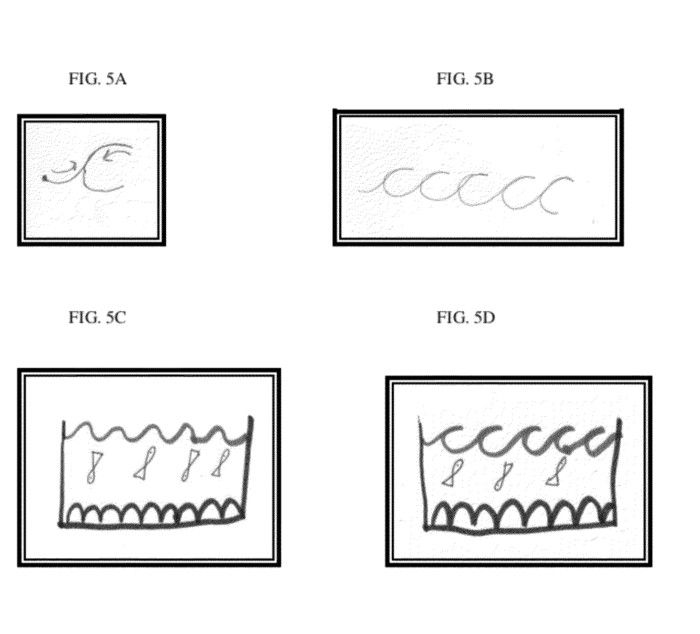

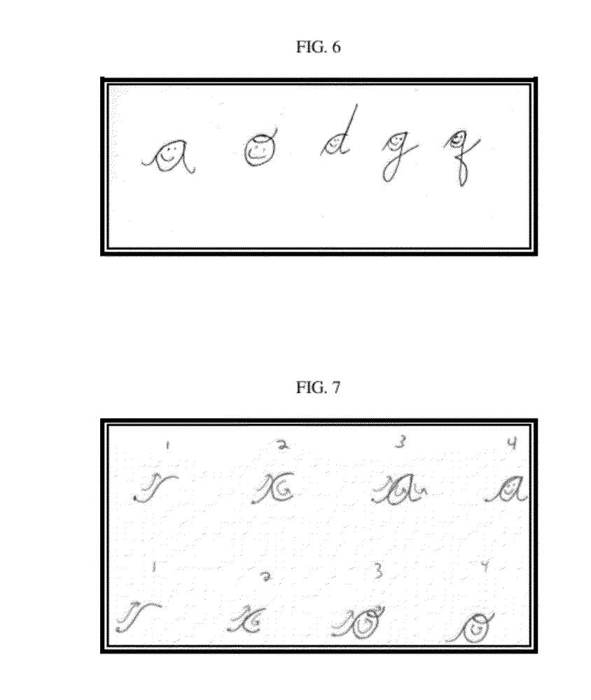

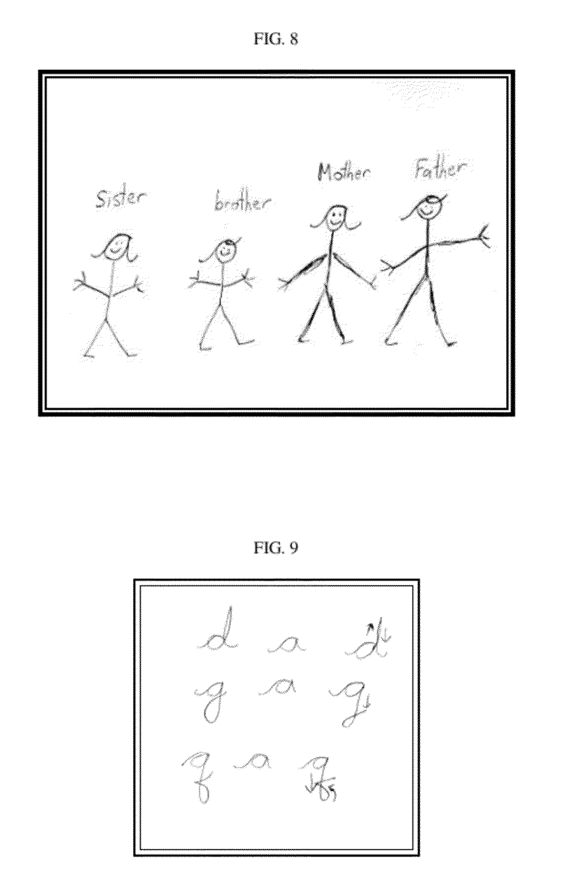

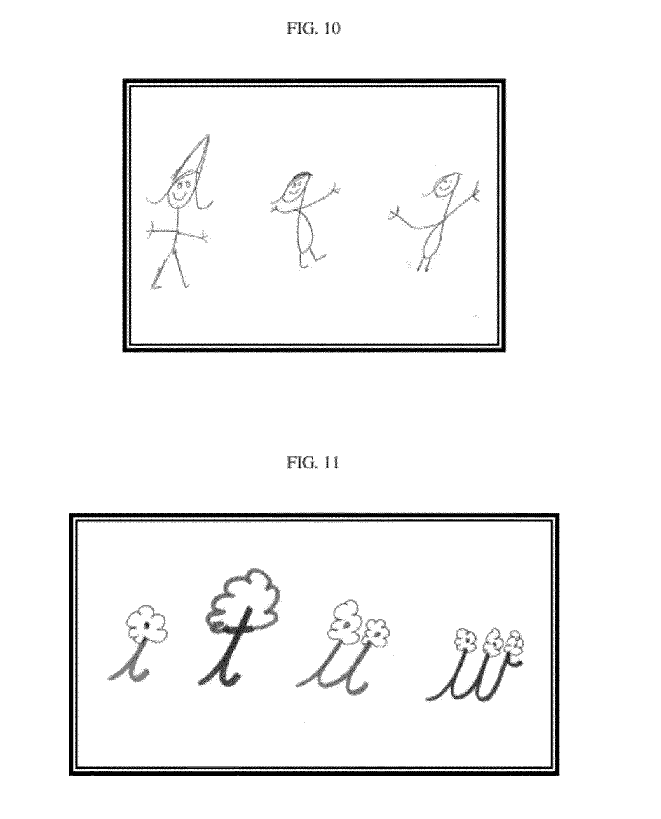

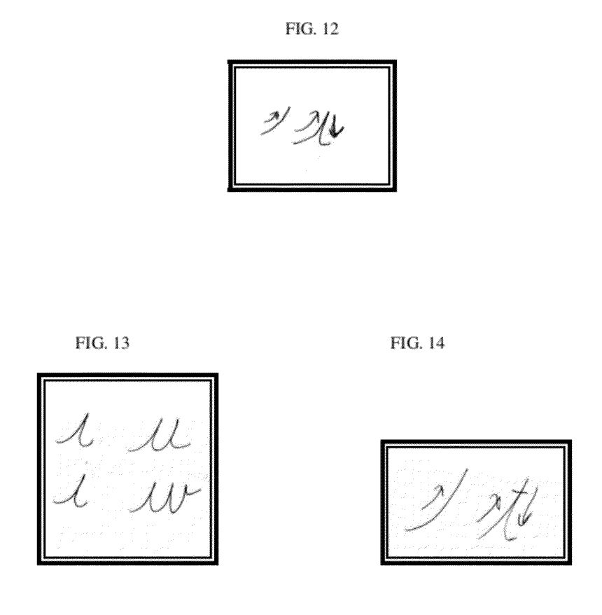

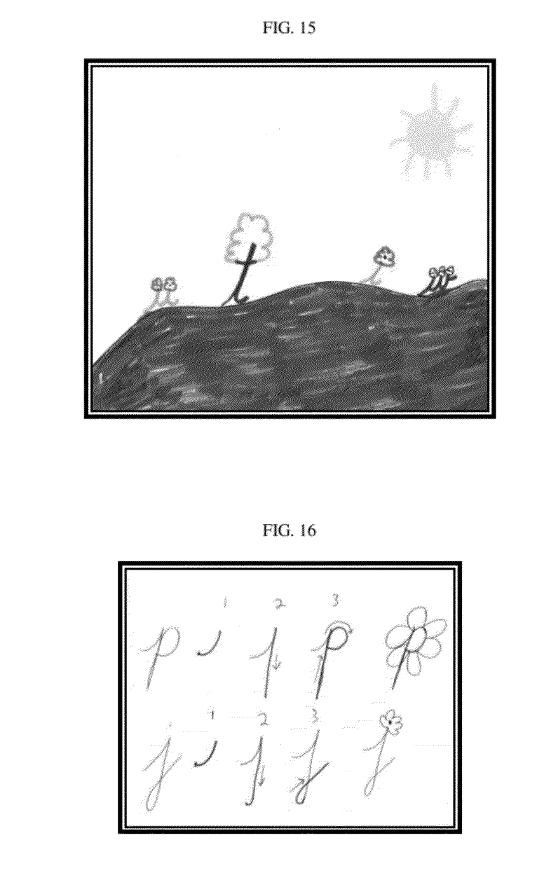

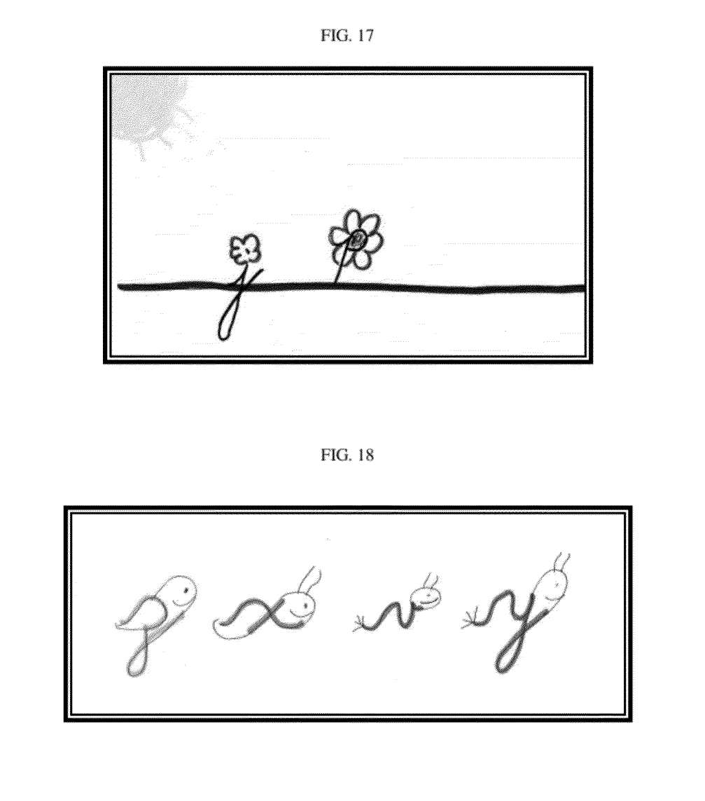

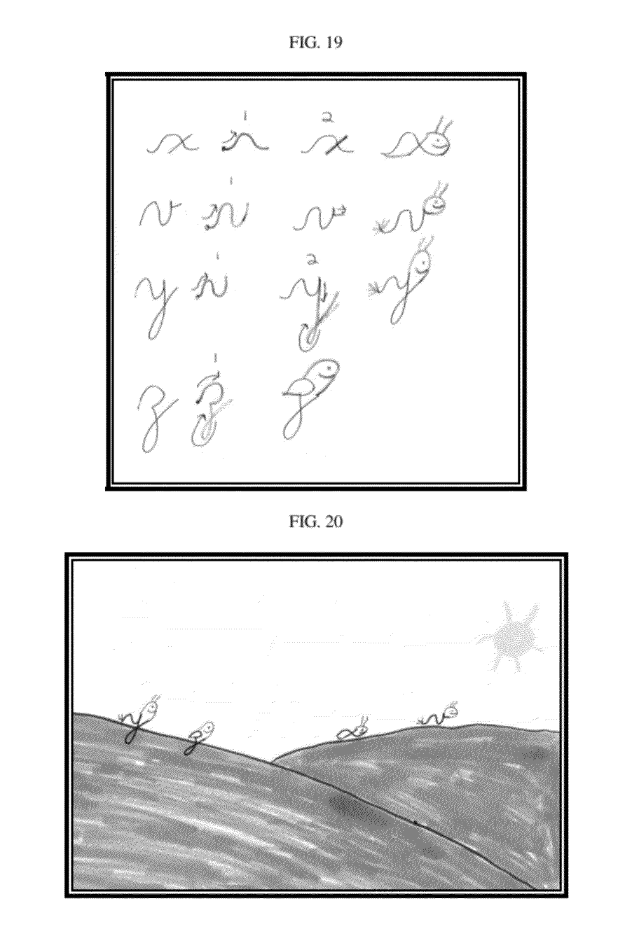

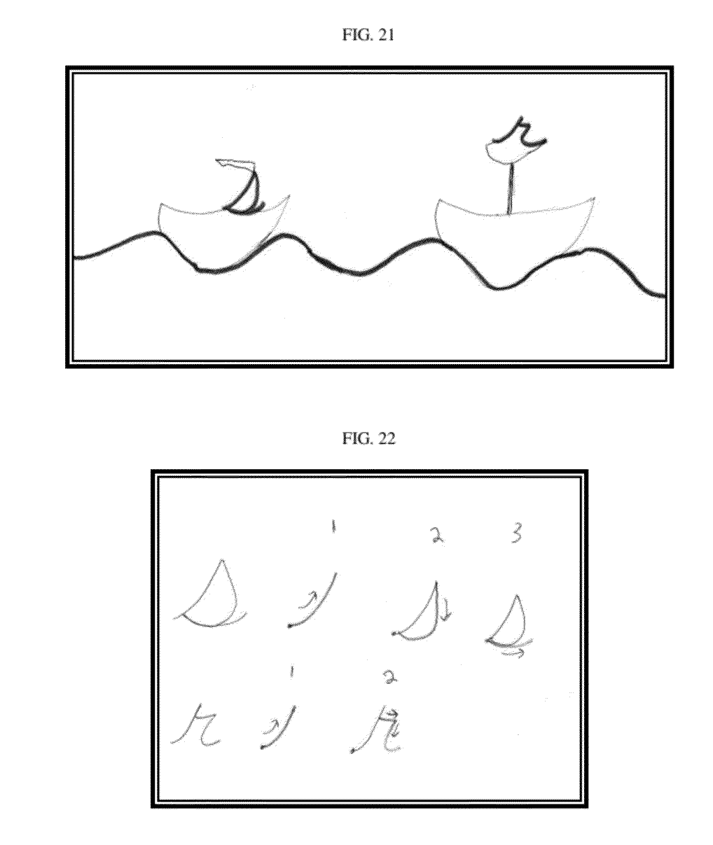

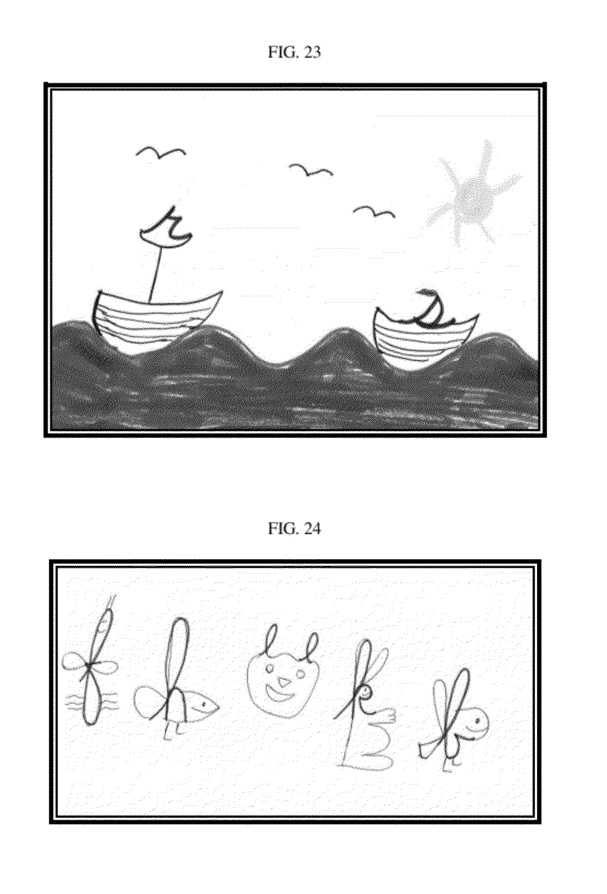

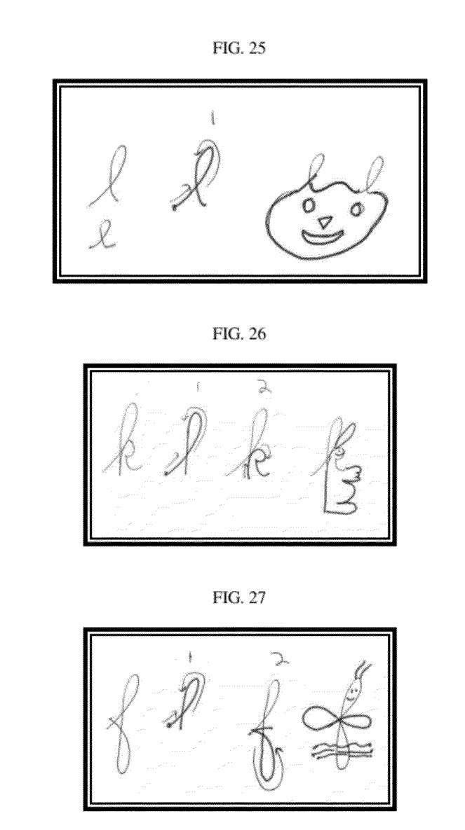

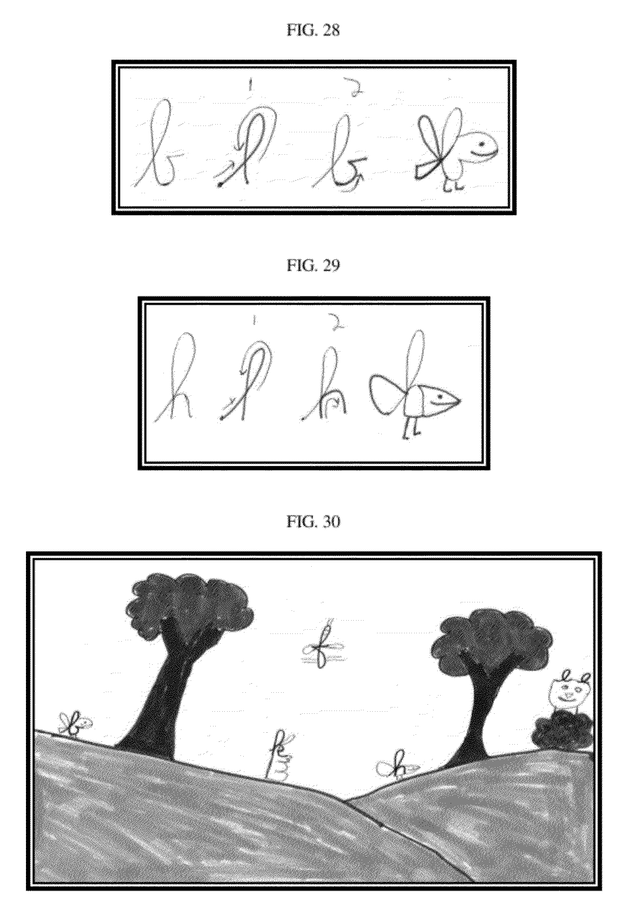

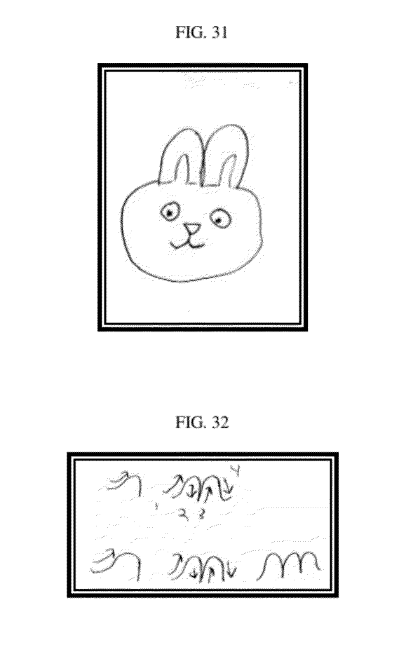

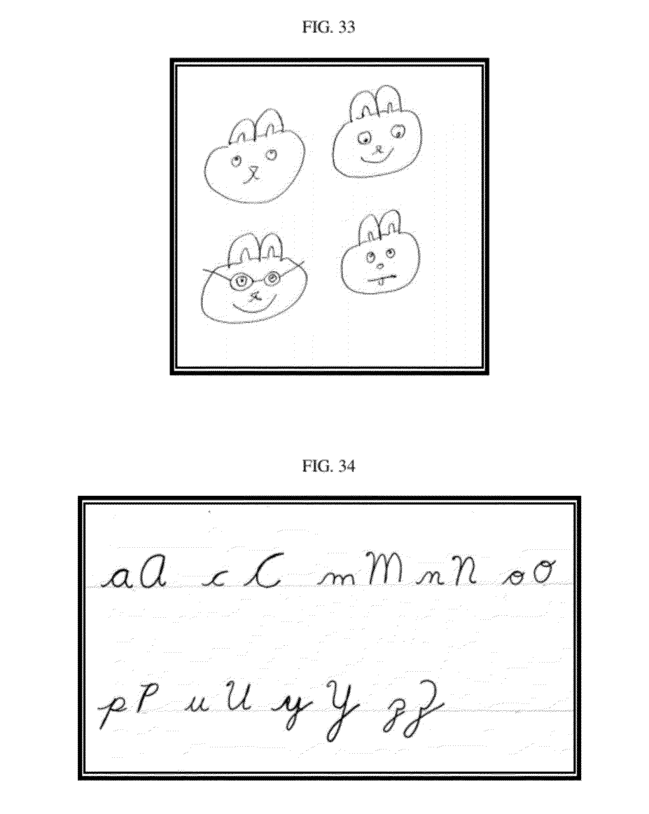

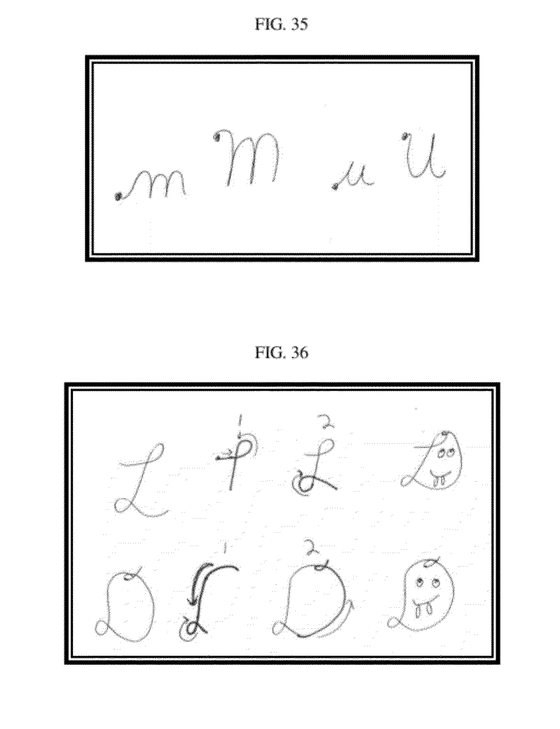

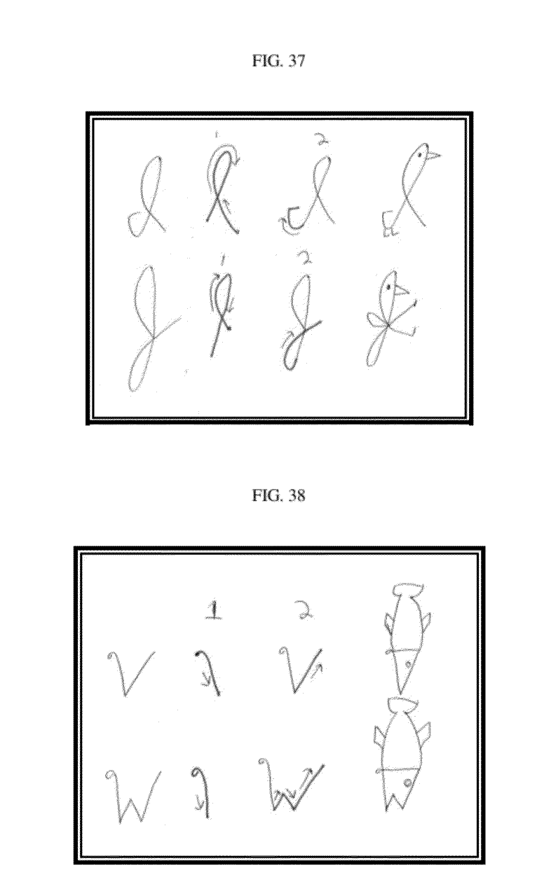

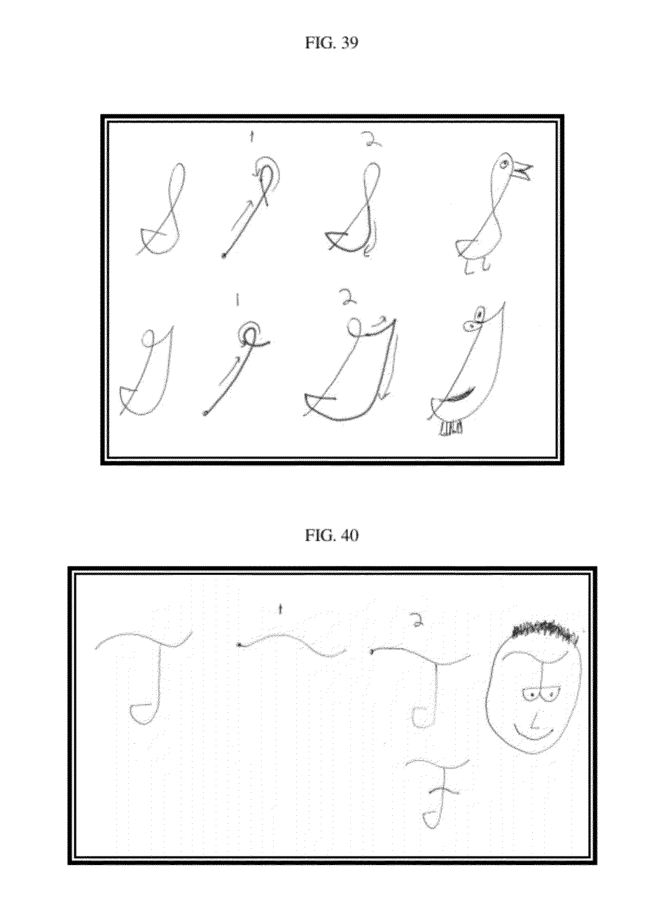

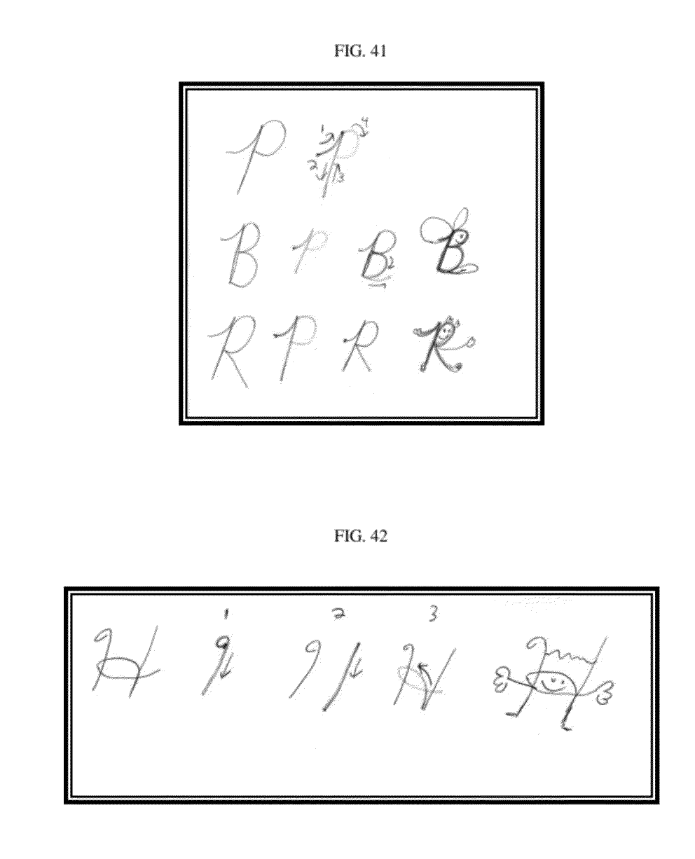

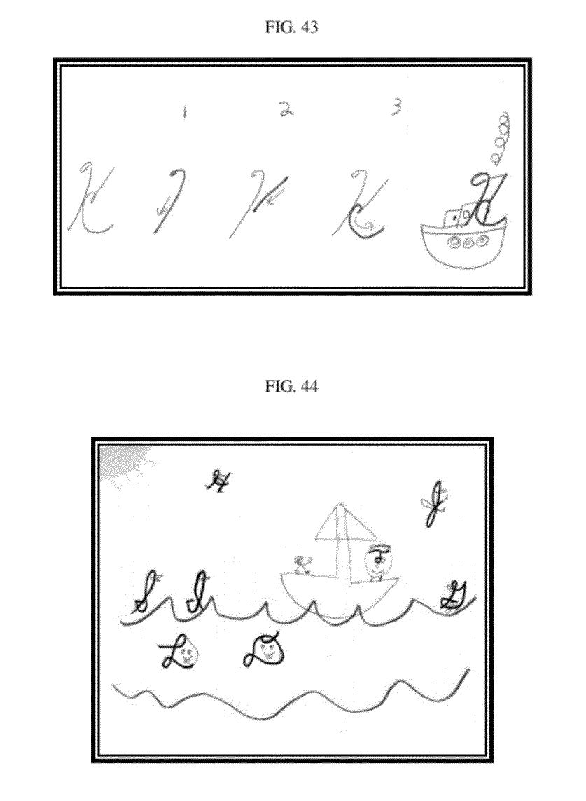

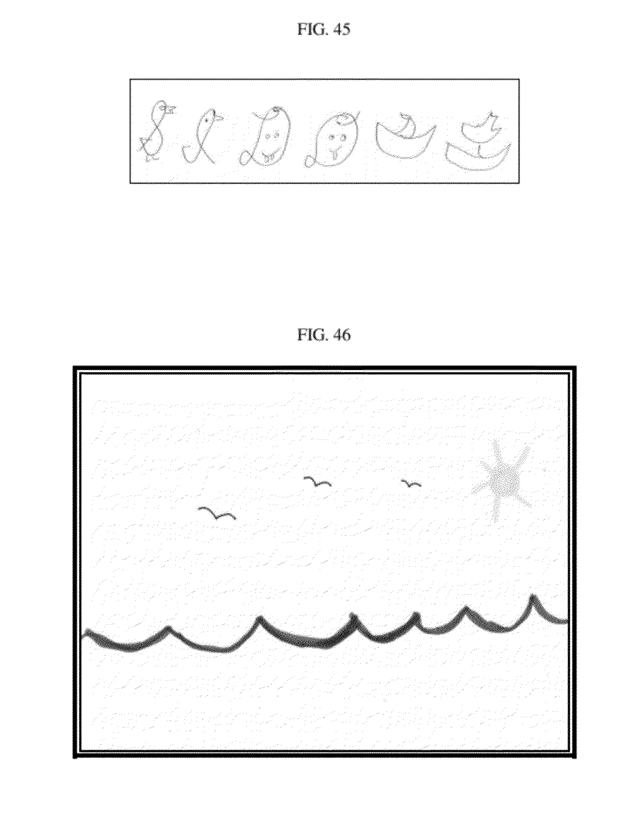

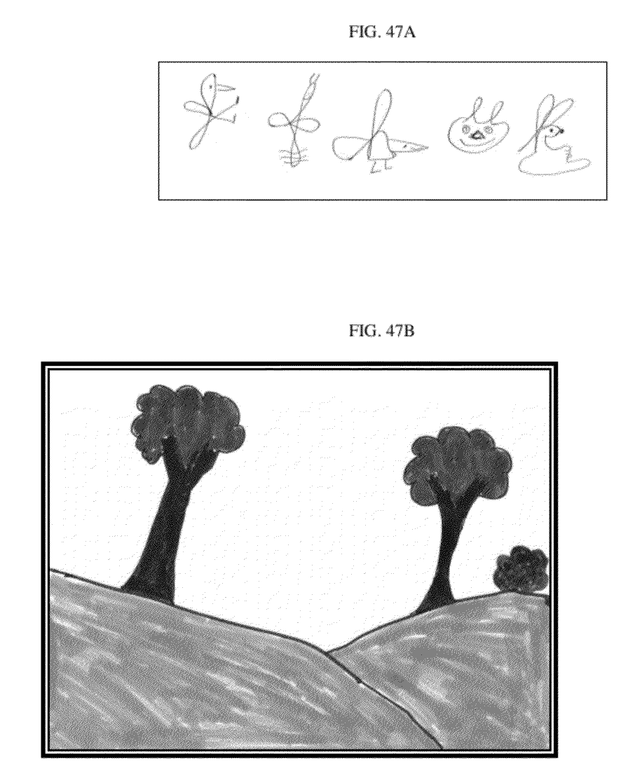

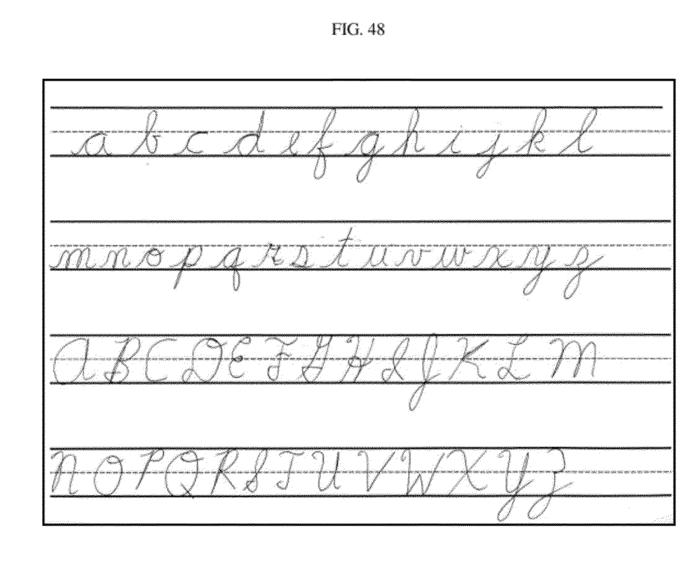

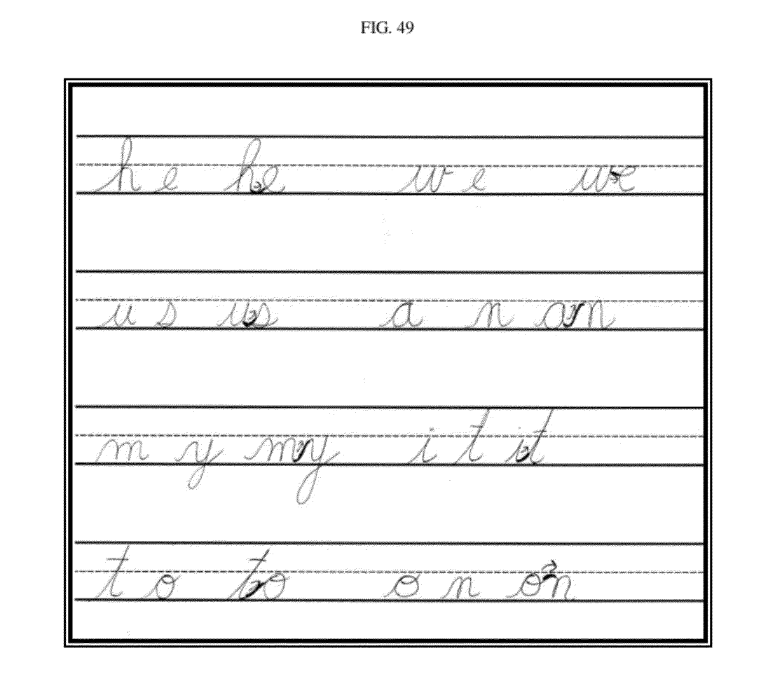

### DETAILED DESCRIPTION OF THE INVENTION

Kinesthetic learning is a type of learning where children use physical movements to learn concepts rather than demonstration. In handwriting, kinesthetic principles emphasize the basic movement patterns of letters. This approach was first used by Mary Benbow, an occupational therapist and handwriting expert who created Loop and Other Groups, a successful handwriting method. Our technique of using the basic geometric shapes such as loops, curves, and ovals is based on these principles. Rather than simply tracing letters in alphabetical order as in most handwriting programs, children learn the basic movement patterns of the letters whether they are upward strokes, loops, or downward strokes. Once they draw these basic shapes, cartoon characters can be created. These cartoons will have cursive letters embedded in them. Thus, children have now formed all upper and lower case cursive letters simply by drawing cartoons.

Learning to draw cartoons is a skill relevant to the children' desires for they will quickly have a product and feel gratified. Children show greater improvement because they enjoy drawing cartoon characters. This method distinguishes itself from other methods by allowing children to produce works of art rather than simply drawing lines or shapes that may not be of interest to them. Cartoon drawing may be viewed as a fun activity and may stimulate the child to more eagerly accomplish the handwriting task.

Studies have demonstrated that teaching art to inner-city children has increased their self-esteem (Unsworth, 1980). Similarly, developing the skills of cartoon drawing facilitates the children's sense of worth and competency. This method can be used with any child, but may be particularly effective with children who have difficulty in learning cursive through traditional means. This fun technique also can enhance rapport between teachers and children.

### Five Basic Shapes

The shapes used in creating cursive letters can be divided into five categories which are the precursor strokes to all cursive letters. They are the wave, hill or hump, upward fish, downward fish, and choppy wave. Once children learn these shapes, they will be able to draw all cursive letters.

The wave is used to start the letter c, a precursor to forming the letters a, d, g, q, and o. This stroke can be made into faces.

The hump or hill creates letters m and n. By repeatedly drawing this stroke, a bumpy floor of an aquarium is formed. Children can then apply these strokes to an aquarium scene. The wave is the water while the humps are the bumpy floor.

The upward swimming fish, consisting of an upward loop, creates letters l and e, and the upper halves of f, h, and b. This can become fish swimming to the surface as seen in. The downward fish consisting of a downward loop, shown in , creates the letter j as well as the lower half of f. Fish can be added to the aquarium. The choppy wave, an extenuation of the original wave with the addition of a backtrack motion, produces the letter c. Children then can create a scene incorporating all five basic shapes. An aquarium can have fish swimming up and down, pebbles on the floor, and either smooth or choppy waves.

### Drawing Cartoons

### Part I Lower Case

The lower case cursive letters can be grouped into cartoon categories based on their formations. We have grouped them into the following categories: faces and people, trees and plants, crawling creatures, sailing, animals, and bunny ears. Taking a step-by-step approach, an adult (parent, teacher, therapist, etc) can demonstrate the proper way to draw a cartoon letter. Children can then draw the cartoons using this step-by step instruction guide. After successfully writing a letter, they can move on to the next.

### Faces and People (a, o, d, g, q)

As previously stated, the cursive c, the choppy wave in chapter two, is a precursor to the letters a, o, q, d, and g. The a and o are the most basic letters, both beginning with the c. Children can practice creating a family based on the formations of the letters a and o. The d, q, and g are formed in a similar way. With each letter, a cursive a is first made; then an upward stroke is followed for the d, while downward loops are used for q and g.
The letters d, g, and q can be used to create people with expression. The picture demonstrates happy people at a party.

### Trees and Plants (i, t, u, w, p, j)

The letters i, u, w, t, p, and j, which have similar strokes, can all be used to create a nature scene with flowers and trees. The i is made with two strokes: first, an upward stroke, and then a downward stroke as seen in FIG.
The u is made by adjoining two “i”s while the “w” comprises three “i”s
The t is simply an elongated “i” with a short horizontal stroke near the top.
These letters can be placed on a hill to create a scene.
The j and p are made with the upward stroke of the I; the p continues with a loop at the top while
the j has a bottom loop similar to the downward swimming fish
The p is flower above the ground and the j is a flower that goes below the ground.

### Crawling Creatures (x, v, y, z)

These letters can form crawling creatures. The x and v crawl above the ground, while the z and y emerge from underground. They all begin with an upward curve.
These cartoons can be incorporated in the scene below.

### Sailing (s, r)

The s and r are made similarly, both starting with the same initial curved upstroke.
Now, the sails on sailboats can be created.

### Animals (e, l, f, b, h, k)

The letters e, l, f b, h, k, all having similar strokes, can create animals. They all start with an upward stroke forming a loop, however differ in their lower sections.
The l and e, the simplest of the letters in the group, are the precursors to the rest of other letters in this group. The l is an elongated e; both letters can make animal ears.
The k comprised the ears and face of a bunny rabbit.
The f creates an insect with wings.
The b and h are very similar and can be used to create birds.
These letters can complete a nature scene.

### Ears (M, N)

The m and n both are comprised of curved “humps” or “hills” which can be used for ears to bunnies or other animals. The n and m are made using these strokes repeatedly.
Children can practice making bunny faces with variations to them all while drawing the bunny ears. Samples of different bunny faces are below.

### Part II

### Capitals

Now that the children have learned to produce all lower case letters, we can move on to capitals. Learning to produce the capitals will be much easier because many of the capitals have similar shapes to their lower case counterparts.
With some of these letters, the starting places may be different.
The remaining capital letters V, W, Q, B, D, E, F, G, H, I, J, K, L, R, S, and T differ from their lower case counterparts. However, children will find these easy to make since all of these letters contain strokes used in lowercase letters. The Q is simply a capital O with a dash projecting through the lower right section. The other letters can each be made into cartoons as demonstrated on the following pages.
The L and D have similar loops.
The I and J are formed via the same motion consisting of an upward loop.
The V and the W are both drawn by using a downward stroke and can form diving fish.
The S and G begin with an upward stroke forming a loop. The loop on the S is larger than the loop on the G.
The formations of the T and F are the same with the only exception being the small horizontal line going through the middle of the letter to form the F.
The R and the B are extensions of the P and can be drawn as shown below.
The H is composed of a series of steps which can produce an insect flying over the water.
The K begins with the same downward stroke as the H and can become a tugboat.
These letters can produce a water scene.

### Chapter 4

### Activities

A good way for children to reinforce their skills is for them to put the cartoon letter together in a landscape drawing. This is a fun activity and will motivate the children to draw more and strive for improvement.
We have included two samples where cartoons from both capital and lower case letters can be put into the appropriate places.
In the water scene, children can add boats, ducks, and fish. Below are samples of letter cartoons and a template.
In the scene below, insects, birds, crawling creatures, people, and animals can be drawn.
After successfully completing these lessons, the child should be able to write all cursive letters in both lower and upper case on standard lined paper.
After the children have successfully written all lower and upper case letters, they can learn to connect the letters to form words. When connecting letters, the child will simply extend the final part of one letter into the next.
Samples are listed in FIG. XX. The bold lines indicate the connections between the letters and the arrows indicate the direction of the stroke.

Teaching cursive writing to students is a significant part of the school curriculum, taught on an individual basis or as whole-class lessons. Teachers, occupational therapists, and other personnel teach these skills to children who may or may not have learning disabilities.

There are many ways to teach cursive writing, some of which are more effective than others. A particular method of writing instruction may benefit one child, but not another. Factors such as the child's interest, skills, and learning styles are extremely important. For example, a child that is a visual learner may benefit more from a teaching style that emphasizes watching the instructor form letters and then copying or imitating his or her actions. Others may learn more easily from verbal instruction and explanation.

Educators are always looking for a “best fit” for a particular student. The term “best fit” considers such factors as those noted above. Consequently, new teaching strategies are continuously being developed. This need to develop new strategies is important in all schools, and especially important in special needs schools.

A particular area of focus, but not of limitation, of the present invention is in the area of schools that specialize in the education of students with behavioral and/or emotional concerns. There are characteristics common to these students that may impede progress with their academic skills. These characteristics may include a need for immediate gratification as well as a need for a completed product or skill that the student feels is important. Many students also have difficulty with self-motivation, and the reason for not completing an assignment may be a simple lack of interest. As a result, teaching techniques for these students require innovative approaches that apply not only to regular academic studies, but to cursive writing as well. Some or all of the challenges associated with special needs students may be present in all students to varying degrees.

Teaching the students first to draw cartoons and then to perform cursive writing has been successful in the special needs forum. The present invention helps students to first learn the basic shapes used in cursive writing; and it seems to alleviate some of the problems impeding the progress of students with special needs. This approach is also consistent with the basic principles of motor learning and of learning theory.

This method may be utilized as a preparatory program for a standard cursive-writing program; the method focuses first on basic shapes but not with the actual letters. After learning this technique, students may then be introduced to a standard cursive-writing program. This method is consistent with the occupational therapy practice framework: domain and process. Students are engaging in occupation (cartoon drawing) to improve a relevant performance skill (cursive writing).

The idea of cartoon drawing to help students learn cursive was first developed after an occupational therapist observed an art teacher teaching his students to draw cartoons. The art teacher's method, which has been used for several years with much success, begins with the students using their index finger to draw shapes in the air. This approach allows the students to refine their visual perceptional skills, which are needed for more advanced drawing. Students would “draw” these shapes using large movements involving the entire arm, an aspect that the art teacher believes improves perception and motor skills.

After mastering this visual perceptional task, the students began to draw shapes on paper. First, they drew circles in the air slightly above the paper. Then, when the students felt the circle was correct, they lightly drew a circle on paper. If the shape was correct, they filled out a standard sheet of paper with circles or other shapes. The students then used these various shapes to draw cartoons, a technique commonly found in cartoon-drawing books.

The occupational therapist recognized the similarities between shapes for cartoons and those for cursive. Through collaboration between the art teacher and the occupational therapist, a new technique was developed for teaching cursive writing. First trialed on a student, D. F., this method subsequently was used with several other students.

Case study

D. F. is a nine-year-old student who has been receiving occupational therapy to improve his writing skills. Over several years he has developed average skills with printing but has had difficulties learning cursive writing. One of the inventors of the present method had used standard writing programs in treating the student. After completing these, D. F. was able to form lower case letters in cursive; however, he had difficulty connecting the letters. His connections were sharp and pointy, with letters cramped together, contributing to words that were barely legible. Numerous methods standard to occupational therapy practice were used to help him properly form these connections. Yet despite many therapy sessions over an entire academic year, D. F. still was unable to connect letters properly in cursive.

D. F. also had difficulty forming capital letters in cursive, especially the letters D, L, I, S and G that are comprised solely of curves. When he tried to form these letters, he simply could not form any of the curves, and he would either draw a stroke in a different direction, or would substitute a curve with two lines forming a sharp point.

D. F. was then taught to make cartoon characters using basic shapes, and his cursive writing improved within a month. His connections consisted of proper concave and convex curves, making his word writing considerably neater. He was also able to form all capital cursive letters correctly. With continued practice in cartoon drawing, D. F.'s cursive writing became more consistent.

### Rationale

Successful cursive-writing programs are kinesthetically-based, which emphasize basic movement patterns of letters (Benbow, 1995). One such method, Loops and other Groups by Mary Benbow, groups letters according to their shape and stresses that students learn basic patterns of one letter and apply them to similarly shaped letters.

The inventors' approach to teaching cursive through cartoons uses a similar kinesthetic approach. Students first learn to draw basic shapes and then use these shapes to draw cartoon characters. There is a similarity between the basic strokes of cartoon drawing and those of cursive writing: circles, ovals, loops, and convex and concave curves are present in both. Students who acquire basic skills learned through cartoon drawing can apply them effectively to cursive writing. In addition, learning to draw curves helps students to connect letters as well as form them: The connections are primarily composed of convex and concave curves. This is an important attribute of the method of the present invention because many students have difficulty connecting cursive letters. Often students will crowd letters together and produce sharp pointed connections instead of smooth curves.

This method also relates to the kinesthetic approach because of its use of repetition, which is instrumental in kinesthetically-based writing programs (Benbow, 1995). Repetition is important in learning new skills (Lee, 1991). It causes basic skills to become automatic, allowing for more complex tasks to be learned (Ignico, 1994). This process is especially important in writing when the students should be focused on the content of what they are writing rather than the formation of letters which should be automatic. Mastering a skill such as cursive writing will enable a student to concentrate on grammar and style required for writing, instead of the formation of the cursive letters.

The present invention has further benefits, for it addresses common difficulties that children experience when learning cursive. The inventors have observed students who “draw” the letters rather than write them. They use short sketchy lines to draw a single character, often retracing each segment of the letter. The inventors have also noted that children who produce automatic cursive strokes tend to learn cursive more easily. Accordingly, the inventors have developed the theory, and resultant method that encapsulates the theory, that cartoon drawing allows skills to become automatic, partly because it requires the student to draw the same shape repeatedly.

This model of drawing cartoons to teach cursive to students also helps satisfy the need for a product or skill relevant to them, and the need for immediate gratification that often accompanies students with special needs. After a few short sessions of drawing shapes, students not only are able to produce a product, but they create something that they find enjoyable.

What most distinguishes this method from other cursive teaching methods may be the meaning that it provides for the students. Students are not simply drawing lines or shapes that may or may not be relevant to them, but rather drawing pictures that capture the students' interest. Research indicates that providing meaning to activities increases the effort and desired outcome (Ferguson & Trombly, 1997). Therefore, the inventors believe that the students will show greater improvement because they are likely to enjoy drawing cartoon characters. Cartoon drawing may be viewed as a fun activity and may stimulate the student to more eagerly accomplish the handwriting task.

Finally, the drawing of cartoons may have the additional beneficial aspect of improving self-esteem. Other studies have demonstrated that teaching art to inner-city students has increased their self-esteem (Unsworth, 1980).

The method of the present invention finds additional strength in the fact that is flexible enough to allow individual instructors to tailor it to their needs. The instructor can be a trained teaching professional, or even an untrained individual. The student may comprise children in a classroom setting, or any individual desirable of learning handwriting, or in improving their currents skills.

The steps of the present invention do not need to be performed in any particular order to be most effective. It is preferable, however, to introduce the cartoon item early on in the process in order to retain the idea that the instruction is going to be more of an amusing exercise rather than work for the student. In that vein, the instructor may first introduce the cartoon item. This instructor May ask the students to observe the proper way to draw the cartoon item, or may simply provide the student access to the cartoon item and ask that it be reproduced. The most effective method is to have the student observe the proper formation of the cartoon item by the instructor.

The student would then be instructed to reproduce the cartoon item. In a preferred embodiment, the cartoon item would be repeated a certain number of times. However, unlike simply repeating a letter alone, the student will enjoy the repetition of the cartoon item, not fully realizing that an array of handwriting skills is being taught.

Upon mastery of the cartoon item, or upon satisfaction of the instructor, the students' attention may be drawn toward the handwriting element portion of the cartoon item. The instructor may employ an embodiment of the present invention by subtly emphasizing the handwriting element of the cartoon item initially. This may be accomplished by slowing down the demonstration during the handwriting element portion, using different colors for different portions of the cartoon item, bolding certain elements of the cartoon item, or simply calling the students' attention to a particular element. At this point, the handwriting element may be drawn alone, apart from the cartoon item. If the handwriting element comprises a complete letter, the student may be alerted to this fact. If the handwriting element comprises a portion of a letter, the instructor may continue to demonstrate the remaining portions of the letter, indicating how the complete letter is formed.

As the student now reproduces the handwriting elements apart from the cartoon items, the student will recall the cartoon items from which the handwriting elements came. This slight shift of focus is enough to transform the exercise from one that is dull and boring, to a more fun-filled endeavor.

Another variation within the scope of the invention is the integration of classical teaching methods. Less advanced students may benefit from first tracing the cartoon items as they are introduced by the instructor. The instructor may still demonstrate the proper form for creating the cartoon item, but the student may benefit from having the added guide of the traceable item. When the handwriting elements are presented apart from the cartoon items, they also may utilize tracing methods to ensure the desired level of competency has been achieved by the student. The desired level of competency or proficiency will vary depending upon the student and the instructor. Where tracing is not desired, broken lines may also be used, as is well known in the art.

Examples of cartoon items have been given, but those skilled in the art will recognize that the versatility of the present invention allows for almost any cartoon item that the instructor, or student, wishes to use. The cartoon item may be realistic looking pictures, or completely fanciful figures and characters. The term “cartoon” is used merely to refer to a drawing of some kind, that is, something other than only the letters themselves, and is not meant to be restrictive in any sense.

The inventors' method was used with students ranging in age from 8-14 who have had difficulty learning cursive through traditional cursive writing programs. These students had various difficulties such as connecting letters, sketching letters, or writing letters with sharp edges and points instead of smooth curves. This technique was also used with students who were simply resistant to learning cursive.

After performing cartoon drawing, students show a greater willingness to learn the basic shapes of cursive than those taught with a traditional cursive method. They also more readily participated in the activity, and with a greater effort. Also, the students appeared to learn basic shapes at a faster rate and produced more accurate shapes. When the students transferred these skills to cursive writing, they produced considerably neater words and letters than in the past. The entire task was much easier and more enjoyable.

This model had been shown to be effective with students who sketch their letters, have difficulty with connecting letters, or have difficulty making smooth strokes. It has also been effective with students with behavioral problems. Some students who had lacked initiative previously would engage in cartoon drawing because they thought it was fun and interesting. This technique can be applied to schools with more mainstreamed student populations, because the technique is based on basic principles of kinesthetics and motor learning. The effectiveness of this new technique for teaching cursive writing demonstrates that alternative methods may prove to be a significant development for therapists, teachers, and parents who are closely involved with the child's academic growth.

Those skilled in the art will also recognize that the method of the present invention may be practiced via all forms of media. This includes print media, such as books, posters, cards and the like, all forms of electronic media, including computers, video, audio, and other electronics. The method does not require that the instructor be actually present with the student or students, and also does not require that the instructor be present during the instruction. For example, the method may be utilized via a computer program where the student interacts with a computer only at their own pace, or the instruction could be given via a book, teleconference, webcast, recorded material, or any other form of communication.

Although the present invention has been described with reference to particular embodiments, it will be apparent to those skilled -in the art that variations and modifications can be substituted therefore without departing from the principles and spirit of the invention.

1. A method for drawing cursive letters, said method comprising the steps of:
drawing a basic shape, wherein said basic shape is chosen from the group consisting of a smooth wave, a hill, an upward fish, a downward fish, or a choppy wave; and
drawing a cartoon element, wherein said cartoon element includes said basic shape.

2. The method of claim 1, further comprising the step of drawing a scene comprising said cartoon element.

3. The method of claim 1, wherein the smooth wave further comprises a first writing element, and wherein said first writing element may be used to start the cursive lowercase letter “C” and wherein said first writing element may be used as a precursor to forming the cursive lowercase letters A, D, G, Q, and O.

4. The method of claim 1, wherein the hill further comprises a second writing element, and wherein said second writing element may be used to form the cursive lowercase letters M and N.

5. The method of claim 1, wherein the upward fish further comprises a third writing element, and wherein said third writing element may be used to form the cursive lowercase letters L, and E and wherein said third writing element may also be used to form the upper halves of the cursive lowercase letters F, H and B.

6. The method of claim 1, wherein the downward fish further comprises a fourth writing element, and wherein said fourth writing element may be used to form the cursive lowercase letter “J” and wherein said fourth writing element may also be used to form the lower half of the cursive lowercase letter F.

7. The method of claim 1, wherein the choppy wave further comprises a fifth writing element, and wherein said fifth writing element may be used to form the lowercase letter C.

8. A method for improving the proper creation of a lowercase cursive letter, said method comprising the steps of:
drawing a cursive letter;
creating a cartoon from said lowercase cursive letter.

9. The method of claim 8 wherein said lowercase cursive letter is chosen from the group consisting of an A and O.

10. The method of claim 9, wherein said cartoon comprises a face.

11. The method of claim 8 wherein said lowercase cursive letter is chosen from the group consisting of D, Q, or G.

12. The method of claim 11, wherein said cartoon comprises a person.

13. The method of claim 8 wherein said lowercase cursive letter is chosen from the group consisting of I, T, U, W, P, or J.

14. The method of claim 13, wherein said cartoon comprises a flower or a tree.

15. The method of claim 8 wherein said lowercase cursive letter is chosen from the group consisting of X, V, Y, or Z.

16. The method of claim 15, wherein said cartoon comprises a crawling creature.

17. The method of claim 8 wherein said lowercase cursive letter is chosen from the group consisting of S or R.

18. The method of claim 17, wherein said cartoon comprises a sailboat.

19. The method of claim 8 wherein said lowercase cursive letter is chosen from the group consisting of E, L, F , B, H, or K.

20. The method of claim 19, wherein said cartoon comprises an animal.

21. The method of claim 8, wherein said lowercase cursive letter is chosen from the group consisting of m or n.

22. The method of claim 21 wherein said cartoon comprises an animal's ears.

23. A method for reinforcing writing skills for cursive letters of an alphabet, said method comprising the steps of:
creating a basic cursive stroke;
drawing a first cartoon element comprising said basic cursive stroke;
writing a cursive letter, wherein said cursive letter comprises said basic cursive stroke;
drawing a second cartoon element comprising said cursive letter;
implementing said first cartoon element and said second cartoon element into a landscape drawing;
writing said cursive letter on a piece of standard lined paper; and
repeating said step of writing said cursive letter on a piece of standard lined paper for each letter of the alphabet; and
connecting said letters of the alphabet to form a word.
